(19) United States
(12) Patent Application Publication
(10) Pub. No.: US 2025/0393088 A1
(43) Pub. Date: Dec. 25, 2025

(54) TRANSMISSION STATION, TRANSMISSION METHOD AND TRANSMISSION PROGRAM

(71) Applicant: NIPPON TELEGRAPH AND TELEPHONE CORPORATION, Tokyo (JP)

(72) Inventors: Akira KISHIDA, Musashino-shi (JP); Yusuke ASAI, Musashino-shi (JP); Yasushi TAKATORI, Musashino-shi (JP); Junichi IWATANI, Musashino-shi (JP); Hirantha ABEYSEKERA, Musashino-shi (JP); Riku OMIYA, Musashino-shi (JP); Shinya OTSUKI, Musashino-shi (JP); Hanae OTANI, Musashino-shi (JP)

(73) Assignee: NIPPON TELEGRAPH AND TELEPHONE CORPORATION, Tokyo (JP)

(21) Appl. No.: 18/878,684

(22) PCT Filed: Jul. 5, 2022
(86) PCT No.: PCT/JP2022/026720

§ 371 Date: Dec. 24, 2024

(51) Int. Cl. H04W 76/15

(52) U.S. Cl. CPC H04W 76/15

(57) ABSTRACT

The transmission station according to an embodiment includes a wireless signal processing unit and a management unit. The management unit establishes a plurality of links between the wireless signal processing unit and a reception station using the wireless signal processing unit, and enables the wireless signal processing unit to transmit data to the reception station through only arbitrary one of the plurality of links at the same timing. In a case where target data to be transmitted is transmitted to the reception station through a target link that is arbitrary one of a plurality of links, the management unit sets a transmission standby time for the target data on the basis of the number of transmission failures of the target data through the target link.

### TECHNICAL FIELD

An embodiment of the present invention relates to a transmission station, a transmission method, and a transmission program.

### BACKGROUND ART

A wireless local area network (LAN) is known as a communication system that wirelessly transmits data from a transmission station to a reception station. In a wireless LAN conforming to the IEEE 802.11 standard, a distributed coordination function (DCF) is adopted as a control system for controlling access to a channel in transmission of data from a transmission station. In the DCF, a transmission station of a wireless LAN performs carrier sensing based on carrier sense multiple access with collision avoidance (CSMA/CA), and transmits data when a transmission right is acquired. Moreover, in the DCF, in a case where target data to be transmitted is retransmitted from the transmission station after transmission of the target data fails, the parameter used to decide the backoff period is exponentially increased according to binary exponential backoff (BEB), thereby increasing the transmission standby time in retransmission of the target data with respect to first transmission of the target data.

Moreover, in IEEE 802.11be under development as a successor standard to IEEE 802.11ax, an enhanced multi link single radio (EMLSR) mode is defined for wireless communication with two communication stations. In the EMLSR mode, a link set including a plurality of links is established between two communication stations, that is, between a transmission station and a reception station. Moreover, in the EMLSR mode, data can be transmitted from a transmission station to a reception station through only arbitrary one of a plurality of links in a link set at the same timing, while data cannot be transmitted from the transmission station to the reception station in parallel through the plurality of links.

In wireless communication in the EMLSR mode described above, it is required to improve efficiency in data transmission from the transmission station to the reception station. For example, in wireless communication in the EMLSR mode, after transmission of target data to be transmitted through one link in the link set fails, the target data may be retransmitted through another link in the link set. In such a case, it is required to suppress an increase in transmission standby time in retransmission of the target data and to improve efficiency in transmission of the target data.

### CITATION LIST

### Non Patent Literature

Non Patent Literature 1: IEEE P802. 11be™/D1.5, “35.3.17 Enhanced multi-link single radio operation”, 18, Mar. 2022.

### SUMMARY OF INVENTION

### Technical Problem

An object of the present invention is to provide a transmission station, a transmission method, and a transmission program capable of improving efficiency in data transmission from a transmission station in wireless communication in an EMLSR mode.

### Solution to Problem

In an embodiment of the present invention, the transmission station includes a wireless signal processing unit and a management unit. The management unit establishes a plurality of links between the wireless signal processing unit and a reception station using the wireless signal processing unit, and enables the wireless signal processing unit to transmit data to the reception station through only arbitrary one of the plurality of links at the same timing. In a case where target data to be transmitted is transmitted to the reception station through a target link that is arbitrary one of the plurality of links, the management unit sets a transmission standby time for the target data on the basis of the number of transmission failures of the target data through the target link regardless of the total number of transmission failures of the target data in the plurality of links.

### Advantageous Effects of Invention

The present invention provides a transmission station, a transmission method, and a transmission program capable of improving efficiency in data transmission from a transmission station in wireless communication in an EMLSR mode.

### BRIEF DESCRIPTION OF DRAWINGS

FIG. 1 is a block diagram illustrating an example of a configuration of a communication system according to an embodiment.

FIG. 2 is a schematic diagram illustrating an example of link management information between an AP and a terminal in the communication system according to the embodiment.

FIG. 3 is a block diagram illustrating an example of a hardware configuration of the AP according to the embodiment.

FIG. 4 is a block diagram illustrating an example of a hardware configuration of the terminal according to the embodiment.

FIG. 5 is a block diagram illustrating an example of a functional configuration of the AP according to the embodiment.

FIG. 6 is a block diagram illustrating an example of a functional configuration of the terminal according to the embodiment.

FIG. 7 is a block diagram illustrating an example of a functional configuration of a channel access function of the terminal according to the embodiment.

FIG. 8 is a flowchart illustrating an example of processing in transmission of target data to be transmitted through a target link, which is arbitrary one of a plurality of links in a link set, performed by a management unit of the terminal according to the embodiment.

FIG. 9 is a schematic diagram illustrating an example of a temporal change in a communication state through a link set of a wireless signal processing unit in the terminal according to the embodiment.

### DESCRIPTION OF EMBODIMENTS

Hereinafter, an embodiment of the present invention will be described with reference to the drawings.

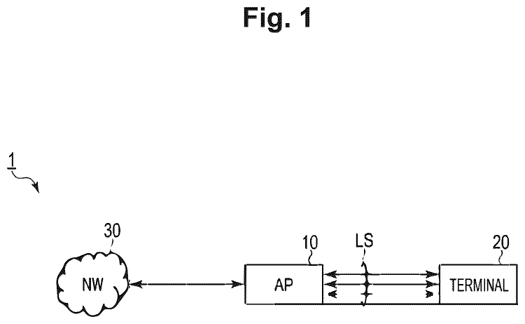

FIG. 1 is a block diagram illustrating an example of a configuration of a communication system 1 according to the embodiment. As illustrated in FIG. 1, the communication system 1 includes an access point (which will be hereinafter referred to as an “AP”) 10, a terminal 20, and a network 30. In a wireless LAN or the like, the AP 10 is also referred to as a “base station”. The AP 10 Communicates with a server (not illustrated) on the network 30 in a wired or wireless manner. The terminal 20 is, for example, a smartphone, a mobile phone, a tablet personal computer (PC), a desktop PC, a laptop PC, or an Internet of things (IoT) sensor/device.

The AP 10 can be wirelessly connected with the terminal 20, and wirelessly communicates with the terminal 20. The wireless communication between the terminal 20 and the AP 10 conforms to the IEEE 802.11 standard. Note that, although wireless communication conforming to the IEEE 802.11 standard will be described as an example in the following description, a wireless communication standard different from the IEEE 802.11 standard may be used.

Each of the AP 10 and the terminal 20 has a wireless communication function based on an open systems interconnection (OSI) reference model defined in the IEEE 802.11 standard. In the OSI reference model, a wireless communication function is divided into seven layers (a first layer: a physical layer, a second layer: a data link layer, a third layer: a network layer, a fourth layer: a transport layer, a fifth layer: a session layer, a sixth layer: a presentation layer, and a seventh layer: an application layer). The data link layer serving as the second layer includes a logical link control (LLC) sublayer and a media access control (MAC) sublayer.

Wireless connection and wireless communication are performed between the AP 10 and the terminal 20 in an enhanced multi link single radio (EMLSR) mode defined in IEEE 802.11be. In wireless communication in the EMLSR mode, a link set LS including a plurality of links is established between the AP 10 and the terminal 20. Each of the plurality of links in the link set LS is established using an STA function provided as a functional configuration in each of the AP 10 and the terminal 20. In the following example, the AP 10 is provided with a plurality of STA functions, and the terminal 20 is provided with only one STA function. In each of the AP 10 and the terminal 20, the STA function corresponds to a wireless signal processing unit to be described later.

One of the plurality of STA functions of the AP 10 and the STA function of the terminal 20 are used to establish one link. Therefore, each of the plurality of links in the link set LS is established using corresponding one of the plurality of STA functions of the AP 10 and the STA function of the terminal 20. Accordingly, only one STA function provided in the terminal 20 is used to establish all the links constituting the link set LS.

In the communication system 1 in the EMLSR mode, wireless communication is performed between the AP 10 and the terminal 20 using a plurality of links constituting the established link set LS. However, in a case where data (uplink data) is transmitted from the terminal 20 to the AP 10, the data can be transmitted from the terminal 20 serving as the transmission station to the AP 10 serving as the reception station through only arbitrary one of the plurality of links in the link set LS at the same timing. That is, in the communication system 1 in the EMLSR mode, data cannot be transmitted from the terminal 20 to the AP 10 in parallel through a plurality of links. Note that, in the communication system 1 in the EMLSR mode, the terminal 20 may be able to receive data (downlink data) from the AP 10 in parallel through a plurality of links in the link set LS, or may be able to receive data from the AP 10 through only arbitrary one of the plurality of links in the link set LS at the same timing.

Here, a terminal provided with only one STA function in the communication system 1 operating in the EMLSR mode, such as the terminal 20, will also be referred to as a “single radio (SR) terminal”. Moreover, in the following description, only one STA function provided in the terminal 20 in the communication system 1 operating in the EMLSR mode will also be denoted by a reference sign “EMLSRSTA”. The AP 10 and the terminal 20 manage the state of a link between the AP 10 and the terminal 20, including the state of the link set LS, by the link management information.

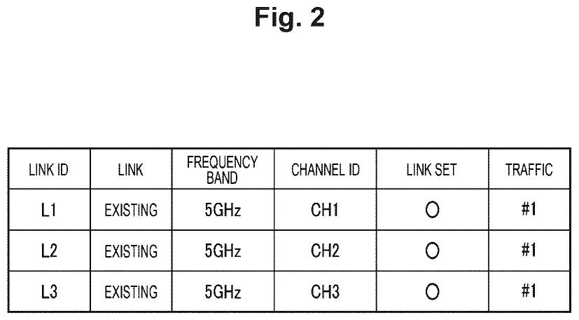

FIG. 2 is a schematic diagram illustrating an example of link management information between the AP 10 and the terminal 20 in the communication system 1 according to the embodiment. The link management information indicates, for example, information on each of a “link ID”, a “link”, a “frequency band”, a “channel ID”, a “link set”, and “traffic”. The “link ID” is an identifier of a link. In the example in FIG. 2, in the AP 10, three STA functions (STA1, STA2, and STA3) are allocated to wireless communication with the terminal 20. In addition, STAI can establish a link L1 between the STA1 and the terminal 20, STA2 can establish a link L2 between STA2 and the terminal 20, and STA3 can establish a link L3 between STA3 and the terminal 20. Information on a “link” indicates whether each of the plurality of STA functions of the AP 10 has established a link between the STA itself and the terminal 20 or not. The example in FIG. 2 illustrates a state in which each of STA1 to STA3 of the AP 10 has established a link between the STA itself and the terminal 20, and a state in which each of the links L1 to L3 has been established.

Information on a “frequency band” indicates a frequency band allocated to each link. As the frequency band, for example, a 6 GHz band, a 5 GHz band, and a 2.4 GHz band can be applied. Each frequency band includes a plurality of channels. The “channel ID” indicates an ID of a channel allocated to each of the links. In the example in FIG. 2, a channel CH1 having a 5 GHz band, a channel CH2 having a 5 GHz band, and a channel CH3 having a 5 GHz band are respectively allocated to the link L1, the link L2, and the link L3. Note that, in the plurality of links in the link set LS, different frequency bands may be respectively allocated, or different channels having the same frequency band may be respectively allocated.

Information on a “link set” indicates whether a link set LS including a plurality of links has been established between the AP 10 and the terminal 20 or not. Moreover, in a case where the link set LS has been established, the information on the “link set” indicates which link constitutes the link set LS. In the example in FIG. 2, the three links L1 to L3 constitute the link set LS.

Information on “traffic” indicates a traffic indicator (TID) of traffic allocated to each link. The TID is an identifier indicating each piece of traffic, and each piece of traffic may be associated with an access category. The access category of traffic includes, for example, a “voice (VO)”, a “video (VI)”, a “best effort (BE)”, a “background (BK)”, and a “low latency (LL)”. In the example in FIG. 2, a TID #1 corresponds to any of VO, VI, BE, BK, and LL. In addition, the traffic of the TID #1 is allocated to each of the links L1 to L3. That is, each of the links L1 to L3 is allocated to transmission and reception of the TID #1.

In the communication system 1 in the EMLSR mode, a plurality of links in the link set LS may be allocated to transmission of one piece of traffic from the terminal 20 to the AP 10. In this case, the terminal 20 transmits the traffic to the AP 10 through arbitrary one of the plurality of links allocated to transmission of the traffic. Moreover, in a case where the transmission of the traffic fails in first transmission, the terminal 20 retransmits the traffic to the AP 10 through a link different from the link used for the first transmission among the plurality of links allocated to the transmission of the traffic.

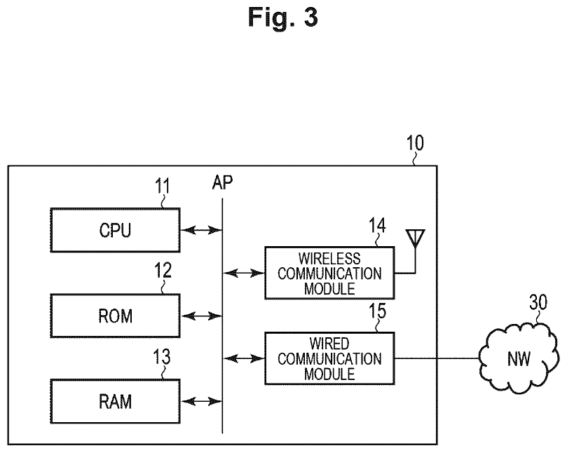

FIG. 3 is a block diagram illustrating an example of a hardware configuration of the AP 10 according to the embodiment. As illustrated in FIG. 3, the AP 10 includes, for example, a central processing unit (CPU) 11, a read only memory (ROM) 12, a random access memory (RAM) 13, a wireless communication module 14, and a wired communication module 15.

The CPU 11 is a processing circuit that controls the entire operation of the AP 10. The ROM 12 is, for example, a nonvolatile semiconductor memory. The ROM 12 stores a program for controlling the AP 10, and data. The RAM 13 is, for example, a volatile semiconductor memory. The RAM 13 is used as a working area of the CPU 11. The wireless communication module 14 is a circuit used to transmit and receive data in the form of a wireless signal. The wireless communication module 14 is connected with an antenna. The wired communication module 15 is a circuit used to transmit and receive data in the form of a wired signal. The wired communication module 15 is connected with the network 30.

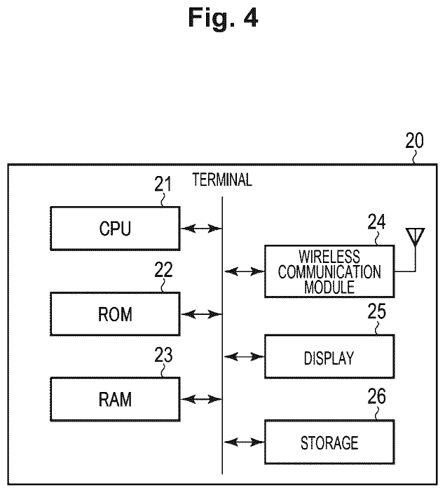

FIG. 4 is a block diagram illustrating an example of a hardware configuration of the terminal 20 according to the embodiment. As illustrated in FIG. 4, the terminal 20 includes, for example, a CPU 21, a ROM 22, a RAM 23, a wireless communication module 24, a display 25, and a storage 26.

The CPU 21 is a processing circuit that controls the entire operation of the terminal 20. The ROM 22 is, for example, a nonvolatile semiconductor memory. The ROM 22 stores a program for controlling the terminal 20, and data. The RAM 23 is, for example, a volatile semiconductor memory. The RAM 23 is used as a working area of the CPU 21. The wireless communication module 24 is a circuit used to transmit and receive data in the form of a wireless signal. The wireless communication module 24 is connected with an antenna. The display 25 is, for example, a liquid crystal display (LCD) or an electro-luminescence (EL) display. The display 25 displays a graphical user interface (GUI) corresponding to application software, or the like. The storage 26 is a nonvolatile storage device. The storage 26 stores system software and the like of the terminal 20.

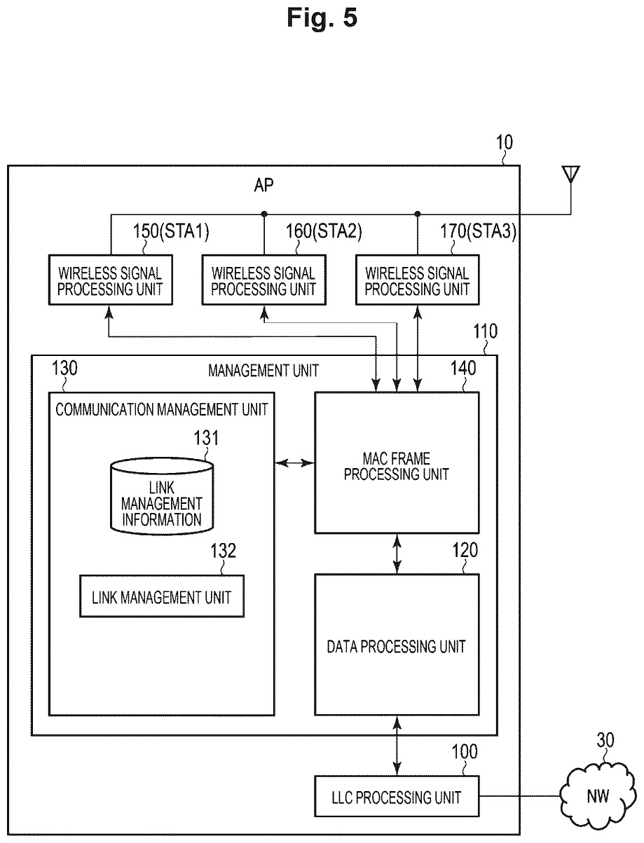

FIG. 5 is a block diagram illustrating an example of a functional configuration of the AP 10 according to the embodiment. As illustrated in FIG. 5, the AP 10 includes, for example, an LLC processing unit 100, a management unit 110, and wireless signal processing units 150, 160, and 170. The processing of the LLC processing unit 100 can be implemented by, for example, a combination of the CPU 11, the RAM 13, and the wired communication module 15. The processing of the management unit 110 and each of the wireless signal processing units 150, 160, and 170 can be implemented by, for example, a combination of the CPU 11, the RAM 13, and the wireless communication module 14. The LLC processing unit 100 executes, for example, processing of an LLC sublayer of the second layer and processing of the third layer to the seventh layer. The management unit 110 executes processing of the MAC sublayer of the second layer. The wireless signal processing units 150, 160, and 170 execute processing of the MAC sublayer of the second layer and processing of the first layer. The management unit 110 includes a data processing unit 120, a communication management unit 130, and an MAC frame processing unit 140.

The LLC processing unit 100 adds a destination service access point (DSAP) header, a source service access point (SSAP) header, and the like to data received from the network 30 to generate an LLC packet. Then, the LLC processing unit 100 inputs the generated LLC packet to the data processing unit 120. Moreover, the LLC processing unit 100 receives the LLC packet from the data processing unit 120 and extracts data from the received LLC packet. Then, the LLC processing unit 100 transmits the extracted data to the network 30.

The data processing unit 120 adds an MAC header to the LLC packet inputted from the LLC processing unit 100 to generate an MAC frame. Then, the data processing unit 120 inputs the generated MAC frame to the MAC frame processing unit 140. Moreover, the data processing unit 120 receives the MAC frame from the MAC frame processing unit 140 and extracts the LLC packet from the received MAC frame. Then, the data processing unit 120 inputs the extracted LLC packet to the LLC processing unit 100. In the following description, the MAC frame including data is also referred to as a “data frame”.

The communication management unit 130 manages the communication state between the AP 10 and the terminal 20, including the state of a link between the AP 10 and the terminal 20. Between the communication management unit 130 and the MAC frame processing unit 140, an MAC frame including management information related to wireless communication, such as management information related to a link, is inputted and outputted. In the following description, the MAC frame including management information is also referred to as a “management frame”. The communication management unit 130 can instruct the MAC frame processing unit 140 to execute predetermined processing by outputting the management frame to the MAC frame processing unit 140. The communication management unit 130 includes, for example, link management information 131 and a link management unit 132. The link management information 131 includes information related to a link between the AP 10 and the terminal 20, and includes, for example, the information illustrated in FIG. 2.

When an MAC frame is inputted from the data processing unit 120 or the communication management unit 130, the MAC frame processing unit 140 associates the inputted MAC frame with a link. Then, for the MAC frame transmitted to the terminal 20, the MAC frame processing unit 140 specifies a link associated with the MAC frame among links in the link set LS. At this time, as the link associated with the MAC frame, one link may be specified from the link set LS, or a plurality of links may be specified. In one example, when a data frame is inputted from the data processing unit 120, the MAC frame processing unit 140 refers to the link management information 131 and specifies a link associated with the TID of the inputted data frame.

The MAC frame processing unit 140 allocates the specified link to transmission of the MAC frame to the terminal 20. Then, the MAC frame processing unit 140 inputs the MAC frame to the specified link, that is, the link allocated to transmission of the MAC frame. As a result, the MAC frame is inputted to a wireless signal processing unit (corresponding one or more of 150, 160, and 170) corresponding to the link allocated to transmission of the MAC frame.

Then, when the MAC frame is inputted from any one of the wireless signal processing units 150, 160, and 170, the MAC frame processing unit 140 inputs the MAC frame to the data processing unit 120 or the communication management unit 130 in accordance with the type of the inputted MAC frame. In a case where the MAC frame is a data frame, the MAC frame is inputted to the data processing unit 120, and in a case where the MAC frame is a management frame, the MAC frame is inputted to the communication management unit 130.

The wireless signal processing units 150, 160, and 170 respectively correspond to the above-described STA1, STA2, and STA3 that are STA functions of the AP 10. The wireless signal processing units 150, 160, and 170 have functional configurations similar to each other. Each of the wireless signal processing units 150, 160, and 170 adds a preamble, a physical layer (PHY) header, and the like to the data inputted from the MAC frame processing unit 140 to generate a wireless frame. Then, each of the wireless signal processing units 150, 160, and 170 performs a predetermined modulation operation on the generated wireless frame to convert the wireless frame into a wireless signal, and radiates (transmits) the wireless signal via an antenna. The predetermined modulation operation includes, for example, convolutional coding, interleaving, subcarrier modulation, inverse fast Fourier transform (IFFT), orthogonal frequency division multiplexing (OFDM) modulation, frequency conversion, and the like.

Moreover, each of the wireless signal processing units 150, 160, and 170 converts a wireless signal from the terminal 20 received via an antenna into a wireless frame by performing predetermined demodulation operation. The predetermined demodulation operation includes, for example, frequency conversion, OFDM demodulation, fast Fourier transform (FFT), subcarrier demodulation, deinterleaving, and Viterbi decoding. Then, each of the wireless signal processing units 150, 160, and 170 extracts an MAC frame from the wireless frame, and inputs the extracted MAC frame to the MAC frame processing unit 140. Note that the wireless signal processing units 150, 160, and 170 may share the same antenna or may use different antennas.

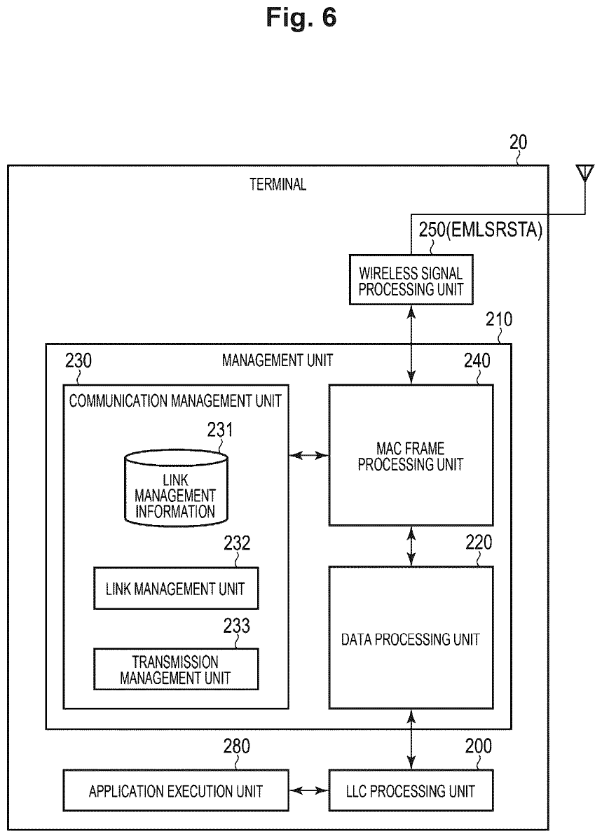

FIG. 6 is a block diagram illustrating an example of a functional configuration of the terminal 20 according to the embodiment. As illustrated in FIG. 6, the terminal 20 includes, for example, an application execution unit 280, an LLC processing unit 200, a management unit 210, and a wireless signal processing unit 250. Processing of each of the application execution unit 280 and the LLC processing unit 200 can be implemented by, for example, the CPU 21 and the RAM 23. Processing of each of the management unit 210 and the wireless signal processing unit 250 can be implemented by, for example, a combination of the CPU 21, the RAM 23, and the wireless communication module 24. The application execution unit 280 executes processing of the seventh layer, and the LLC processing unit 200 executes processing of an LLC sublayer of the second layer and processing of the third layer to the sixth layer. The management unit 210 executes processing of the MAC sublayer of the second layer, and the wireless signal processing unit 250 executes processing of the MAC sublayer of the second layer and processing of the first layer. The management unit 210 includes a data processing unit 220, a communication management unit 230, and an MAC frame processing unit 240.

The application execution unit 280 executes an application on the basis of data inputted from the LLC processing unit 200. Moreover, the application execution unit 280 inputs data to the LLC processing unit 200 in accordance with the operation of the application. The application execution unit 280 can display application information on the display 25. Moreover, the application execution unit 280 can execute processing corresponding to an operation at the input interface.

The LLC processing unit 200 adds a DSAP header, an SSAP header, and the like to data received from the application execution unit 280 to generate an LLC packet. Then, the LLC processing unit 200 inputs the generated LLC packet to the data processing unit 220. Moreover, the LLC processing unit 200 receives the LLC packet from the data processing unit 220 and extracts data from the received LLC packet. Then, the LLC processing unit 200 inputs the extracted data to the application execution unit 280.

The data processing unit 220 adds an MAC header to the LLC packet inputted from the LLC processing unit 200 to generate an MAC frame. Then, the data processing unit 220 inputs the generated MAC frame to the MAC frame processing unit 240. Moreover, the data processing unit 220 receives the MAC frame from the MAC frame processing unit 240 and extracts the LLC packet from the received MAC frame. Then, the data processing unit 220 inputs the extracted LLC packet to the LLC processing unit 200.

The communication management unit 230 cooperates with the communication management unit 130 of the AP 10 to manage the communication state between the AP 10 and the terminal 20 including the state of a link between the AP 10 and the terminal 20. An MAC frame (management frame) containing management information related to wireless communication, such as management information related to a link, is inputted and outputted between the communication management unit 230 and the MAC frame processing unit 240. The communication management unit 230 can instruct the MAC frame processing unit 240 to execute predetermined processing by outputting the management frame to the MAC frame processing unit 240. The communication management unit 230 includes, for example, link management information 231, a link management unit 232, and a transmission management unit 233. The link management information 231 includes information related to a link between the AP 10 and the terminal 20, and includes, for example, the information illustrated in FIG. 2.

When an MAC frame is inputted from the data processing unit 220 or the communication management unit 230, the MAC frame processing unit 240 associates the inputted MAC frame with a link. Then, for the MAC frame to be transmitted to the AP 10, the MAC frame processing unit 240 specifies a link associated with the MAC frame among links in the link set LS. At this time, as the link associated with the MAC frame, one link may be specified from the link set LS, or a plurality of links may be specified. In one example, when a data frame is inputted from the data processing unit 220, the MAC frame processing unit 240 specifies a link associated with the TID of the data frame. The MAC frame processing unit 240 allocates the specified link to transmission of the MAC frame to the AP 10. Then, the MAC frame processing unit 240 inputs the MAC frame to the wireless signal processing unit 250 together with an instruction to transmit the MAC frame through the allocated link.

Moreover, when the MAC frame is inputted from the wireless signal processing unit 250, the MAC frame processing unit 240 inputs the MAC frame to the data processing unit 220 or the communication management unit 230 in accordance with the type of the inputted MAC frame. In a case where the MAC frame is a data frame, the MAC frame is inputted to the data processing unit 220, and in a case where the MAC frame is a management frame, the MAC frame is inputted to the communication management unit 230.

The wireless signal processing unit 250 corresponds to an EMLSRSTA that is only one STA function provided in the terminal 20. Therefore, the wireless signal processing unit 250 establishes a plurality of links constituting the link set LS between the wireless signal processing unit 250 and the AP 10. The wireless signal processing unit 250 adds a preamble, a physical layer (PHY) header, and the like to the data inputted from the MAC frame processing unit 240 to generate a wireless frame. Then, the wireless signal processing unit 250 performs a predetermined modulation operation on the wireless frame to convert the wireless frame into a wireless signal, and radiates (transmits) the wireless signal via an antenna. The predetermined modulation operation is performed similarly to the predetermined modulation operation in each of the wireless signal processing units 150, 160, and 170.

The wireless signal processing unit 250 transmits a wireless signal using a link allocated to transmission among a plurality of links (a plurality of channels) in the link set LS. Note that, in the wireless signal processing unit 250, it is impossible to transmit wireless signals in parallel through a plurality of the links constituting the link set LS as described above. Therefore, in a case where a plurality of links is allocated to transmission of data to the AP 10, the wireless signal processing unit 250 transmits data to the AP 10 through only any one of the plurality of links allocated to transmission at the same timing.

Moreover, the wireless signal processing unit 250 converts a wireless signal from the AP 10 received via an antenna into a wireless frame by performing a predetermined demodulation operation. The predetermined demodulation operation is performed similarly to the predetermined demodulation operation in each of the wireless signal processing units 150, 160, and 170. Then, the wireless signal processing unit 250 extracts the MAC frame from the wireless frame, and inputs the extracted MAC frame to the MAC frame processing unit 240. In one example, the wireless signal processing unit 250 monitors each of the links (channels) in the link set LS, and when detecting a wireless signal in any of the links, inputs an MAC frame corresponding to the detected wireless signal to the MAC frame processing unit 240.

In one example, the wireless signal processing unit 250 can receive wireless signals in parallel, that is, at the same timing through a plurality of links constituting the link set LS. Moreover, in another example, the wireless signal processing unit 250 can receive the wireless signal from the AP 10 through only arbitrary one of the plurality of links in the link set LS at the same timing. Note that, in the wireless signal processing unit 250, an antenna may be shared by the plurality of links (plurality of channels) in the link set LS, or one antenna may be provided for each of the plurality of links.

In the functional configurations illustrated in FIGS. 5 and 6, the link management unit 132 of the AP 10 and the link management unit 232 of the terminal 20 cooperate with each other to control establishment of a link between the AP 10 and the terminal 20. In the control of establishment of the link, for example, the link management units 132 and 232 execute association processing and authentication processing subsequent to the association processing in response to a connection request from the terminal 20 to the AP 10. The link management units 132 and 232 control the state of the link established between the AP 10 and the terminal 20. In the process of establishing the link set LS between the AP 10 and the terminal 20, the link management units 132 and 232 may associate the TIDs of the traffic with the links in the link set LS. Moreover, in the control of establishment of the link and the control of the established link, the link management unit 132 refers to the link management information 131, and the link management unit 232 refers to the link management information 231.

Moreover, in a state where the link set LS is not established, the link management units 132 and 232 cooperate with each other to set up the link set LS. In the setup of the link set LS, any one of the wireless signal processing units 150, 160, and 170 (STA1 to STA3) of the AP 10 communicates with the wireless signal processing unit 250 (EMLSRSTA) of the terminal 20. In one example, in the setup of the link set LS, the link management unit 232 causes the terminal 20 to transmit a probe request to the AP 10, and the link management unit 132 causes the AP 10 to transmit a probe response to the terminal 20 as a response to the probe request. Then, when the terminal 20 receives the probe response, the link management unit 232 causes the terminal 20 to transmit an association request for the link set LS to the AP 10.

When the AP 10 receives the association request, the link management unit 132 performs association processing on the link set LS. At this time, on the basis of the completion of the association processing for any one of the plurality of links constituting the link set LS, the link management unit 132 also completes the association processing for links other than said link. Accordingly, the link management unit 132 performs association processing on all the links constituting the link set LS using one link, and recognizes that all the links constituting the link set LS have been established between the AP 10 and the terminal 20. As a result, the link management unit 132 recognizes that the link set LS has been established between the AP 10 and the terminal 20. When the association processing is completed, the link management unit 132 updates the link management information 131. Then, the link management unit 132 causes the AP 10 to transmit a response indicating that the link set LS has been established to the terminal 20. Then, the link management unit 232 updates the link management information 231 on the basis of reception of the response indicating establishment of the link set LS by the terminal 20.

In the functional configuration illustrated in FIGS. 5 and 6, the transmission management unit 233 of the Communication management unit 230 of the terminal 20 manages transmission of data from the terminal 20 to the AP 10. The terminal 20 that is an SR terminal is provided with a channel access function. The transmission management unit 233 controls access to a channel by controlling operation by the channel access function of the terminal 20 in transmission of data from the terminal 20 serving as a transmission station.

In the terminal 20, for example, one channel access function is provided in the wireless signal processing unit 250. Then, the channel access function checks the status of one link for transmitting data among the plurality of links constituting the link set LS. Note that, in one example, the channel access function is provided in the MAC frame processing unit 240 instead of the wireless signal processing unit 250. Moreover, in another example, the same number of channel access functions as the number of the links constituting the link set LS are provided in the wireless signal processing unit 250, and one channel access function is provided for each of the plurality of links in the link set LS. Then, each of the plurality of channel access functions checks the status of corresponding one link among the links in the link set LS.

In a case where the target data to be transmitted is transmitted from the terminal 20 to the AP 10 through a target link that is arbitrary one of the plurality of links constituting the link set LS, the channel access function of the terminal 20 performs carrier sensing based on carrier sense multiple access with collision avoidance (CSMA/CA) and checks the status of a channel allocated to the target link. In transmission of the target data through the target link, a standby time by an inter frame space (IFS) is set as a fixed transmission standby time. Carrier sensing for the target link is started at the end of the standby time by the IFS or during the standby time by the IFS. The channel access function of the terminal 20 checks whether the target link is in an idle state or a busy state by carrier sensing. By performing the carrier sensing, collision of the target data with other data transmitted and received through a channel allocated to the target link is effectively avoided.

Moreover, in a case where the target data is transmitted through the target link, a backoff period is set as a transmission standby time for avoiding collision of the target data with other data. The backoff period starts from the end time point of the IFS. The channel access function of the terminal 20 performs carrier sensing at least in the backoff period, and checks the status of a channel allocated to the target link. In a case where the target link is in the idle state throughout the standby time by the IFS and the backoff period, the channel access function of the terminal 20 acquires the transmission right of the target data through the target link. Then, the channel access function terminates the carrier sensing and transmits the target data to the AP 10 through the target link. On the other hand, in a case where the target link is in a busy state during the standby time by the IFS and during the backoff period, the channel access function of the terminal 20 terminates the carrier sensing and stops the process of acquiring the transmission right for the target data.

The length of the backoff period that is a transmission standby time for collision avoidance changes according to the value of a contention window (CW). Therefore, the contention window is a parameter used to decide the length of the backoff period. The transmission management unit 233 can adjust the length of the backoff period by adjusting the value of the contention window, and can adjust the length of the period during which carrier sensing is performed. The backoff period is more likely to be longer as the value of the contention window becomes larger.

In one example, in transmission of the target data from the terminal 20 to the AP 10, short inter frame space (SIFS) is set as the IFS described above. In this case, the backoff period described above is started from the end time point of the SIFS. Then, the channel access function of the terminal 20 performs carrier sensing in response to the start of the backoff period, and performs a process of acquiring the transmission right for the target data as described above. In another example, in transmission of the target data from the terminal 20 to the AP 10, a distributed coordination function (DCF) inter frame space (DIFS) longer than the SIFS is set as the IFS described above. In this case, the backoff period described above is started from the end time point of the DIFS. However, the channel access function of the terminal 20 starts carrier sensing before the backoff period is started, that is, before the end time point of the DIFS, and performs a process of acquiring the transmission right for the target data as described above. In a case where DIFS is set, carrier sensing is started at a time point when a predetermined time corresponding to SIFS has elapsed from a start time point of DIFS.

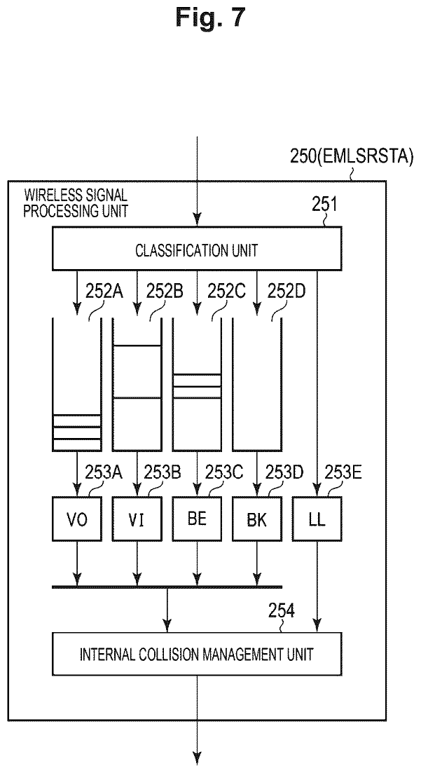

FIG. 7 is a block diagram illustrating an example of a functional configuration of a channel access function of the terminal 20 according to the embodiment. In the example in FIG. 7, one channel access function is provided in the wireless signal processing unit 250. In the example in FIG. 7, the channel access function includes, for example, a classification unit 251, queues 252A, 252B, 252C, and 252D, carrier sensing execution units 253A, 253B, 253C, 253D, and 2538, and an internal collision management unit 254.

In the example in FIG. 7, when a data frame as an MAC frame is inputted to the channel access function, the classification unit 251 classifies the inputted data frame into a plurality of access categories on the basis of the TID included in the MAC header. Then, the classification unit 251 inputs the data frame to one of the queues 252A to 252D and the carrier sensing execution unit 253E corresponding to the access category. In the example in FIG. 7, data frames whose access categories are VO, VI, BE, and BK are inputted respectively to the queues 252A, 252B, 252C, and 252D. Moreover, a data frame whose access category requiring low latency is LL is inputted to the carrier sensing execution unit 253E without passing through any of the queues 252A to 252D.

Each of the queues 252A to 252D buffers an inputted data frame. In the example in FIG. 7, the queues 252A, 252B, 252C, and 252D respectively buffer data frames whose access categories are VO, VI, BE, and BK. Each of the carrier sensing execution units 253A to 253E executes carrier sensing based on CSMA/CA as described above according to a preset access parameter. In the example in FIG. 7, the carrier sensing execution units 253A, 253B, 253C, and 253D are provided respectively corresponding to the queues 252A, 252B, 252C, and 252D. Moreover, the carrier sensing execution units 253A, 253B, 253C, 253D, and 253E respectively perform carrier sensing with VO, VI, BE, BK, and LL as corresponding access categories.

The access parameter is set for each access category, and is set, for example, such that transmission of a wireless signal is prioritized in the order of “LL”, “VO”, “VI”, “BE”, and “BK”. As the access parameters, for example, CWmin, CWmax, Arbitration Inter Frame Space (AIFS), or Transmission Opportunity (TXOP) Limit is used. CWmin and CWmax respectively are the minimum value and the maximum value of the contention window (CW) described above. In the example in FIG. 7, since the value of the contention window is set for each access category, the length of the above-described backoff period that is a transmission standby time for collision avoidance is also set for each access category. Moreover, an access category whose values of CWmin and CWmax are set to be smaller is more likely to have a shorter backoff period, and thus the transmission right is acquired more easily.

The AIFS is a fixed transmission standby time corresponding to the IFS described above, and is set for each access category. Carrier sensing is started earlier for an access category whose value of the AIFS is set to be shorter, and thus the transmission right is acquired more easily. Moreover, TXOP Limit indicates an upper limit value of a channel occupancy time TXOP. It is possible to set the amount of data that can be transmitted with a transmission right acquired once to be larger for an access category whose value of TXOP Limit is set to be larger.

Each of the carrier sensing execution units 253A to 253E checks the status of one target link for transmitting target data among a plurality of links (channels) constituting the link set LS by carrier sensing as described above. Then, each of the carrier sensing execution units 253A to 253E acquires the transmission right through the target link for the target data on the basis of the fact that the target link has been in the idle state throughout the standby time by the IFS (AIFS) and the backoff period. Then, each of the carrier sensing execution units 253A to 253E transmits a wireless signal obtained by converting the data frame to the AP 10 through the target link for which the transmission right has been acquired.

The internal collision management unit 254 prevents collision in data transmission in a case where a plurality of the carrier sensing execution units 253A to 253E acquires transmission rights for the same link. For example, in a case where transmission rights of a plurality of pieces of data is acquired in a target link that is arbitrary one of a plurality of links, the internal collision management unit 254 adjusts the transmission timing for each of the plurality of pieces of data for which a transmission right is acquired, and outputs the data to the target link in order from data belonging to an access category with higher priority.

Moreover, in a case where the target data to be transmitted is transmitted from the terminal 20 to the AP 10, the transmission management unit 233 of the communication management unit 230 sets an index indicating the number of transmission failures of the target data through each of the plurality of links constituting the link set LS in the present embodiment including the functional configurations illustrated in FIGS. 5 and 6. For example, in a case where the link set LS includes three links L1 to L3 as in the example in FIG. 2, an index α1 indicating the number of transmission failures of the target data through the link L1, an index α2 indicating the number of transmission failures of the target data through the link L2, and an index α3 indicating the number of transmission failures of the target data through the link L3 are set. In this case, the total value of the indexes α1 to α3 is the total number of transmission failures of the target data in the plurality of links constituting the link set LS.

In a case where the target data is transmitted from the terminal 20 to the AP 10 through a target link Lk that is arbitrary one of the plurality of links constituting the link set LS, the transmission management unit 233 of the communication management unit 230 sets the value of the contention window on the basis of the index αk indicating the number of transmission failures of the target data through the target link Lk. As a result, in the transmission of the target data through the target link Lk, the length of the backoff period is set on the basis of the index αk.

The transmission management unit 233 sets the value of the contention window to be larger as the value of the index αk is larger, that is, as the number of transmission failures of the target data through the target link Lk is larger. For example, in a case where the index αk is 0, the contention window is set to a specified value that is an initial value. Then, the transmission management unit 233 increases the value of the contention window with respect to the specified value in accordance with the increase in the index αk. Therefore, the transmission management unit 233 is more likely to have a longer backoff period as the value of the index αk is larger. In one example, the contention window increases exponentially according to binary exponential backoff (BEB) in accordance with an increase in the index αk. The transmission management unit 233 increases the value of the parameter used to decide the backoff period in accordance with the increase in the number of transmission failures (index αk) of the target data through the target link Lk, thereby increasing the possibility that the transmission standby time, which is the total time of the IFS and the backoff period, becomes longer in the transmission of the target data through the target link Lk.

As described above, the management unit 210 sets the transmission standby time for the target data on the basis of the number of transmission failures of the target data through the target link Lk regardless of the total number of transmission failures of the target data through the plurality of links constituting the link set LS. Therefore, in a case where the index αk indicating the number of transmission failures of the target data through the target link Lk is 0, the value of the contention window is set to a specified value, which is an initial value, in the transmission of the target data through the target link Lk even if the transmission of the target data fails in a link other than the target link Lk. In addition, since the backoff period is set on the basis of the contention window set to the specified value, there is a lower possibility that the backoff period, which is the transmission standby time started from the end time point of the IFS, in the transmission of the target data through the target link Lk increases with respect to the first transmission of the target data performed through a link other than the target link Lk.

In one example, first transmission of target data to be transmitted from the terminal 20 is performed through a first link that is one link in the link set LS. Then, after the first transmission fails, second transmission of the target data from the terminal 20 is performed through a second link that is one link different from the first link in the link set LS. In this case, even when transmission of the target data through the second link is the second transmission of the target data from the terminal 20, the parameter used to decide the transmission standby time such as the contention window is set to the same value as that of the first transmission of the target data from the terminal 20 performed through the first link.

Moreover, when the target data is transmitted from the terminal 20 to the AP 10 through the target link Lk on the basis of the fact that the target link has been in the idle state until the end time point of the backoff period, the transmission management unit 233 or the like determines whether the transmission of the target data has succeeded or not in the present embodiment. The determination as to whether the transmission of the target data has succeeded or not is made on the basis of, for example, whether the wireless signal processing unit 250 has received an acknowledgement (Ack) from the AP 10 during a specified time Tref from the transmission time point of the target data or not. In one example, the Ack is transmitted from the AP 10 to the terminal 20 through the target link Lk that has transmitted the target data from the terminal 20.

In a case where the wireless signal processing unit 250 receives the Ack from the AP 10 during the specified time Tref, the transmission management unit 233 or the like of the management unit 210 determines that the target data has been successfully transmitted. Then, the transmission management unit 233 or the like resets the index indicating the number of transmission failures of the target data through the link to zero for each of the plurality of links constituting the link set LS including the target link Lk. On the other hand, in a case where the wireless signal processing unit 250 has not received the Ack from the AP 10 during the specified time Tref, the transmission management unit 233 or the like determines that the transmission of the target data has failed. Then, the transmission management unit 233 or the like adds 1 to the index αk indicating the number of transmission failures of the target data through the target link Lk. Note that, after the target data is successfully transmitted, the process related to transmission is also performed for data to be transmitted next from the terminal 20 to the AP 10 as described above.

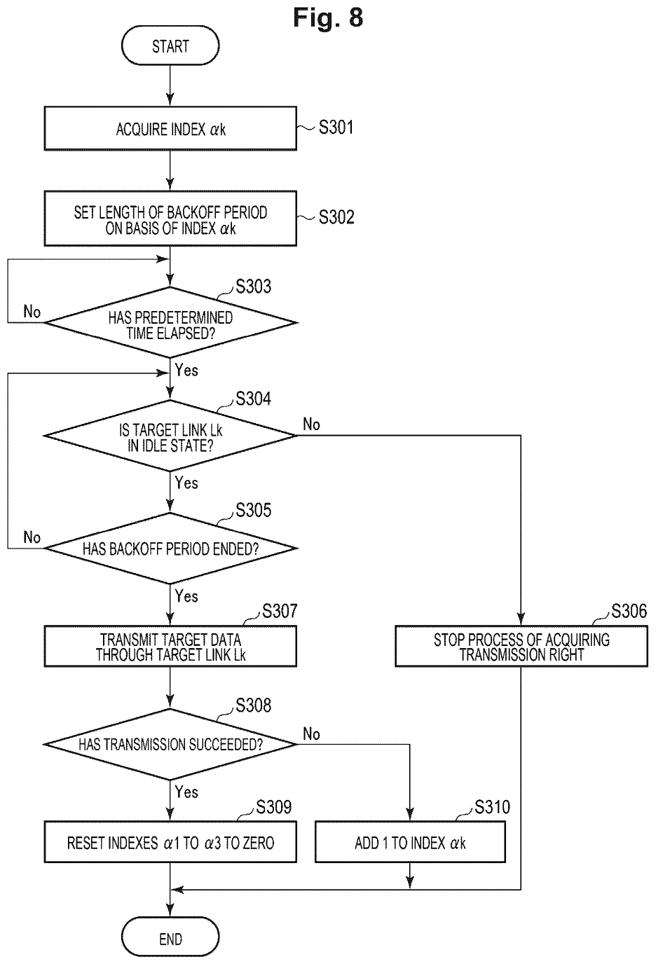

FIG. 8 is a flowchart illustrating an example of processing in transmission of the target data to be transmitted through the target link Lk, which is arbitrary one of the plurality of links in the link set LS, performed by the management unit 210 of the terminal 20 according to the embodiment. The processing of the example in FIG. 8 is performed every time data is transmitted from the terminal 20 to the AP 10 through arbitrary one of the plurality of links constituting the link set LS. Note that, in the example in FIG. 8, the link set LS includes the three links L1 to L3 described above, and it is assumed that arbitrary one of the links L1 to L3 is the target link Lk.

When the processing of the example in FIG. 8 is started, the management unit 210 acquires an index αk indicating the number of transmission failures of the target data through the target link Lk (S301). Then, the management unit 210 sets the length of the backoff period for the transmission of the target data performed through the target link Lk on the basis of the index αk (S302). The length of the backoff period based on the index αk is set as described above. Then, the management unit 210 waits until a predetermined time corresponding to the SIFS elapses from the start time point of the FIS (S303—No).

When the predetermined time elapses (S303—Yes), the management unit 210 causes the channel access function of the terminal 20 to execute carrier sensing and checks the status of a channel allocated to the target link Lk. Then, the management unit 210 determines whether the target link Lk is in the idle state or not (S304). In a case where the target link Lk is in the idle state (S304—Yes), the management unit 210 determines whether the backoff period has ended or not (S305). In a case where the backoff period has not ended (S305—No), the processing returns to S304, and the management unit 210 sequentially performs the processing of S304 and subsequent steps. In a case where the target link Lk is in the busy state in S304 (S304—No), the management unit 210 terminates the carrier sensing and stops the process of acquiring the transmission right of the target data through the target link Lk (S306).

In a case where the backoff period has ended in S305 (S305—Yes), the management unit 210 causes the wireless signal processing unit 250 to transmit the target data to the AP 10 through the target link Lk (S307). Accordingly, the target data is transmitted from the terminal 20 through the target link Lk on the basis of the fact that the target link Lk has been in the idle state throughout the standby time by the IFS and the backoff period. When the target data is transmitted to the AP 10, the management unit 210 determines whether transmission of the target data has succeeded or not (S308). At this time, for example, it is determined that the transmission of the target data has succeeded on the basis of the fact that the wireless signal processing unit 250 has received Ack from the AP 10 during the specified time Tref from the transmission time point of the target data.

In a case where the transmission of the target data has succeeded (S308—Yes), the management unit 210 resets each of the indexes α1 to α3 to zero (S309). That is, for each of the plurality of links constituting the link set LS, the index indicating the number of transmission failures of the target data through the link is reset to zero. On the other hand, in a case where the transmission of the target data has failed (S308—No), the management unit 210 adds 1 to the index ok indicating the number of transmission failures of the target data through the target link Lk (S310).

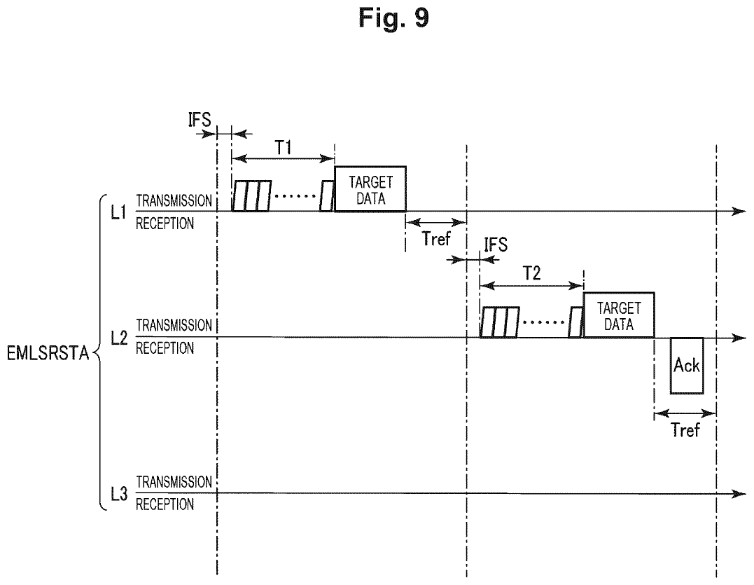

FIG. 9 is a schematic diagram illustrating an example of a temporal change in a communication state through the link set LS of the wireless signal processing unit 250 (EMLSRSTA) in the terminal 20 according to the embodiment. In the example in FIG. 9, the EMLSRSTA of the terminal 20 establishes links L1, L2, and L3 respectively between the EMLSRSTA, and STA1, STA2, and STA3 of the AP 10. In addition, the links L1 to L3 constitute the link set LS. In the example in FIG. 9, the first transmission of the target data to be transmitted to the AP 10 is performed through the link L1. At this time, the contention window is set to a specified value that is an initial value, and the length T1 of the backoff period started from the end time point of the IFS is set on the basis of the specified value of the contention window.

Moreover, in the example in FIG. 1, the EMLSRSTA does not receive the Ack from the AP 10 during the specified time Tref from the first transmission time point of the target data. Therefore, it is determined that the first transmission of the target data has failed, and the second transmission of the target data, that is, transmission of the MAC frame with Retry=1 is performed through the link L2 different from the link L1. Here, at the start time point of the second transmission of the target data, the number of transmission failures of the target data through the link L1 is 1, while the number of transmission failures of the target data through the link L2 is 0.

Therefore, in the example in FIG. 9, also in the second transmission of the target data, the contention window is set to a specified value that is an initial value, and the length T2 of the backoff period started from the end time point of the IFS is decided on the basis of the specified value of the contention window. Accordingly, the upper limit value of the length T2 of the backoff period in the second transmission is equal to the upper limit value of the length T1 of the backoff period in the first transmission. Moreover, in the example in FIG. 9, the EMLSRSTA receives the Ack from the AP 10 during a specified time Tref from the second transmission time point of the target data. Accordingly, it is determined that the transmission of the target data has succeeded by the transmission of the target data through the link L2.

Note that, in one example, the second transmission of the target data is also performed through the link L1 after transmission of the target data fails in the link L1. In this case, the number of transmission failures of the target data through the link L1 is 1, and the index α1 is 1 at the start time point of the second transmission of the target data. Then, on the basis of the index α1, a contention window is set and a backoff period is set. Therefore, in the second transmission of the target data, the contention window is set to a value larger than the specified value, and there is a higher possibility that the backoff period is set longer than that in the first transmission of the target data.

As described above, in a case where the target data to be transmitted is transmitted to the AP 10 through a target link that is arbitrary one of the plurality of links in the link set LS, the transmission standby time for the target data is set on the basis of the number of transmission failures of the target data through the target link regardless of the total number of transmission failures of the target data in the entire link set LS in the present embodiment. Therefore, in a case where the index αk indicating the number of transmission failures of the target data through the target link Lk is 0, the value of the parameter used to decide the transmission standby time such as the contention window in the transmission of the target data through the target link Lk is set to be equal to that of the first transmission of the target data even if the transmission of the target data fails in a link other than the target link Lk. Accordingly, in a case where the target data is retransmitted from the terminal 20 serving as the SR terminal to the AP 10 in the communication system 1 in the EMLSR mode, an increase in the transmission standby time in the retransmission of the target data is appropriately suppressed. As a result, it is possible to improve efficiency in transmission of data from the terminal 20 serving as a transmission station to the AP 10 serving as a reception station.

Note that, although the above embodiment and the like have been described using a case where the AP 10 wirelessly communicates with the terminal 20 using three STA functions and the link set LS between the AP 10 and the terminal 20 includes three links, it is not limited thereto. In the embodiment and the like, the above-described process of transmitting data from the terminal 20 can be executed as long as the link set LS between the AP 10 and the terminal 20 includes a plurality of links and only one EMLSRSTA is provided as the STA function in the terminal 20 serving as a transmission station.

Moreover, the data transmission processing from the terminal 20 described above can also be applied to a transmission station other than the terminal. For example, in a case where an AP provided with only one EMLSRSTA as the STA function transmits data in a communication system in the EMLSR mode, data transmission processing may be performed in the AP similarly to the data transmission processing from the terminal 20 described above.

Moreover, processing according to the above embodiment and the like can be stored as a program that can be executed by a processor that is a computer. Moreover, it is possible to store and distribute a program that executes the above-described processing in a storage medium of an external storage device such as a magnetic disk, an optical disk, or a semiconductor memory. Then, the processor reads the program stored in the storage medium of the external storage device, and the operation is controlled by the read program, whereby processing according to the embodiment or the like can be executed.

Note that the present invention is not limited to the above embodiment, and various modifications can be made in the implementation stage without departing from the gist of the invention. Moreover, embodiments may be implemented in appropriate combination, and in this case, a combined effect can be obtained. Furthermore, the above embodiment includes various inventions, and various inventions can be extracted by a combination selected from a plurality of disclosed components. For example, even if some components are deleted from all the components described in the embodiment, a configuration from which the components have been deleted can be extracted as an invention, as long as the problem can be solved and the effects can be achieved.

### Reference Signs List

1 Communication system
10 Access point (AP)
20 Terminal
30 Network
11, 21 CPU
12, 22 ROM
13, 23 RAM
14, 24 Wireless communication module
15 Wired communication module
25 Display
26 Storage
100, 200 LLC processing unit
110, 210 Management unit
120, 220 Data processing unit
130, 230 Communication management unit
131, 231 Link management information
132, 232 Link management unit
140, 240 MAC frame processing unit
150, 160, 170, 250 Wireless signal processing unit
233 Transmission management unit
251 Classification unit
252A to 252D Queue
253A to 253E Carrier sensing execution unit
254 Internal collision management unit
280 Application execution unit

1. A transmission station comprising:
a wireless signal processing unit; and
a management unit that establishes a plurality of links between the wireless signal processing unit and a reception station using the wireless signal processing unit and enables the wireless signal processing unit to transmit data to the reception station through only arbitrary one of the plurality of links at same timing, the management unit setting a transmission standby time for target data to be transmitted on a basis of a number of transmission failures of the target data through a target link that is arbitrary one of the plurality of links regardless of a total number of transmission failures of the target data through the plurality of links in a case where the target data is transmitted to the reception station through the target link.

2. The transmission station according to claim 1,
wherein the management unit establishes the plurality of links including a first link and a second link between the management unit and the reception station, and
the management unit sets a parameter to be used to decide the transmission standby time for the target data to a value equal to a value of first transmission in a case where second transmission of the target data is performed using the second link as the target link after the first transmission of the target data performed through the first link fails.

3. The transmission station according to claim 1,
wherein the management unit causes the target data to be transmitted through the target link on a basis of a fact that the target link is in an idle state throughout a standby time by an IFS and a backoff period, and
the management unit increases a value of a contention window used to decide a length of the backoff period in accordance with an increase in the number of transmission failures of the target data through the target link in a case of transmitting the target data through the target link.

4. A transmission method comprising:
establishing a plurality of links between a wireless signal processing unit of a transmission station and a reception station, and enabling the wireless signal processing unit to transmit data to the reception station through only arbitrary one of the plurality of links at same timing; and
setting a transmission standby time for target data to be transmitted on a basis of a number of transmission failures of the target data through a target link that is arbitrary one of the plurality of links regardless of a total number of transmission failures of the target data in the plurality of links in a case where the target data is transmitted to the reception station through the target link.

5. A non-transitory storage medium storing a transmission program, the transmission program being capable of causing a computer to:
establish a plurality of links between a wireless signal processing unit of a transmission station and a reception station, and enable the wireless signal processing unit to transmit data to the reception station through only arbitrary one of the plurality of links at same timing; and
set a transmission standby time for target data to be transmitted on a basis of a number of transmission failures of the target data through a target link that is arbitrary one of the plurality of links regardless of a total number of transmission failures of the target data in the plurality of links in a case where the target data is transmitted to the reception station through the target link.
